(19) United States
(12) Patent Application Publication
(10) Pub. No.: US 2024/0258719 A1
(43) Pub. Date: Aug. 1, 2024

(54) COMBINATION TERMINAL

(71) Applicants: AUTONETWORKS TECHNOLOGIES, LTD., Mie (JP); SUMITOMO WIRING SYSTEMS, LTD., Mie (JP); SUMITOMO ELECTRIC INDUSTRIES, LTD., Osaka (JP)

(72) Inventors: Shinji NOZAKI, Mie (JP); Hideto NAKAMURA, Mie (JP); Tetsuya MIYAMURA, Mie (JP); Daisuke SAITO, Mie (JP)

(21) Appl. No.: 18/565,975

(22) PCT Filed: May 27, 2022
(86) PCT No.: PCT/JP2022/021719

§ 371 Date: Nov. 30, 2023

(30) Foreign Application Priority Data
Jun. 15, 2021 (JP) 2021-099237

(51) Int. Cl. H01R 4/48; H01R 4/18; H01R 11/12

(52) U.S. Cl. CPC H01R 4/4835; H01R 4/185; H01R 11/12

(57) ABSTRACT

It is aimed to provide a combination terminal capable of saving assembly time by preventing an increase in the number of components at the time of assembly. A combination terminal is provided with a plurality of terminals (10A, 10B, 10C) to be stacked on each other. Each of the plurality of terminals (10A, 10B, 10C) includes a plate-like base portion (11), a plate-like guided portion (12) projecting from the base portion (11) and a locking portion (13) formed on the guided portion (12). Further, out of the terminals adjacent in a stacking direction, one (10A, 10C) of the terminals includes a guide portion (14L) to be arranged along the guided portion (12U) of the other terminal (10A, 10B, 10C) and a resiliently deformable resilient locking portion (27L) to be locked to the locking portion (13U) of the other terminal (10A, 10B, 10C).

### TECHNICAL FIELD

The present disclosure relates to a combination terminal.

### BACKGROUND

Patent Document 1 discloses a combination terminal provided with a plurality of terminals and a rivet collar. Each terminal is formed with a through hole. The respective terminals are so stacked on each other that the through holes are concentric. The rivet collar couples the respective terminals in a stacking direction while passing through the through holes. The respective terminals are positioned while being shifted in a circumferential direction around the rivet collar.

### PRIOR ART DOCUMENT

### Patent Document

Patent Document 1: JP 2016-081673 A

### SUMMARY OF THE INVENTION

### Problems to be Solved

In the case of Patent Document 1, since the rivet collar separate from the respective terminals is necessary to position the respective terminals, there has been a problem that the number of components increases and assembly becomes cumbersome.

Accordingly, the present disclosure aims to provide a combination terminal capable of saving assembly time by preventing an increase in the number of components at the time of assembly.

### Means to Solve the Problem

The present disclosure is directed to a combination terminal with a plurality of terminals to be stacked on each other, each of the plurality of terminals including a plate-like base portion, a plate-like guided portion projecting from the base portion and a locking portion formed on the guided portion and, out of the terminals adjacent in a stacking direction, one of the terminals including a guide portion to be arranged along the guided portion of the other terminal and a resiliently deformable resilient locking portion to be locked to the locking portion of the other terminal.

### Effect of the Invention

According to the present disclosure, it is possible to provide a combination terminal capable of saving assembly time by preventing an increase in the number of components at the time of assembly.

### BRIEF DESCRIPTION OF THE DRAWINGS

FIG. 1 is a plan view of a second terminal in a combination terminal according to a first embodiment of the present disclosure.

FIG. 2 is a plan view of a first terminal.

FIG. 3 is a perspective view showing a state where two first terminals are arranged at a distance from each other in a vertical direction before assembly.

FIG. 4 is a plan view showing a state where the two first terminals are set in an initial state.

FIG. 5 is a plan view showing a state where the two first terminals are assembled and a combination terminal in two lower levels is formed.

FIG. 6 is a plan view showing a state where assembly is restricted when the two first terminals are erroneously assembled.

FIG. 7 is a perspective view showing a state where the combination terminal in the two lower levels and a combination terminal in two upper levels are arranged at a distance from each other in the vertical direction before assembly.

FIG. 8 is a plan view of the combination terminal.

FIG. 9 is a perspective view of the combination terminal.

FIG. 10 is a perspective view showing a state where two terminals are arranged at a distance from each other in the vertical direction before assembly in a combination terminal according to a second embodiment of the present disclosure.

FIG. 11 is a perspective view of the combination terminal.

### DETAILED DESCRIPTION TO EXECUTE THE INVENTION

### Description of Embodiments of Present Disclosure

First, embodiments of the present disclosure are listed and described.

(1) The terminal of the present disclosure is provided with a plurality of terminals to be stacked on each other, each of the plurality of terminals including a plate-like base portion, a plate-like guided portion projecting from the base portion and a locking portion formed on the guided portion and, out of the terminals adjacent in a stacking direction, one of the terminals including a guide portion to be arranged along the guided portion of the other terminal and a resiliently deformable resilient locking portion to be locked to the locking portion of the other terminal.

The guide portion of the one terminal is arranged along the guided portion of the other terminal and the resilient locking portion of the one terminal is locked to the locking portion of the other terminal, whereby the respective terminals can be positioned and fixed. According to this configuration, since a separate rivet collar is not required unlike before, an increase in the number of components can be prevented and assembly time can be saved.

(2) Preferably, a pair of the guide portions of the one terminal are arranged respectively along both side edges of the guided portion of the other terminal.

According to this configuration, the assembly of the respective terminals is satisfactorily guided and the respective terminals are satisfactorily positioned.

(3) A gap may be formed between the guided portion and the base portion, and the guide portion of the one terminal may be located in the gap of the other terminal and arranged to be able to contact the base portion and the guided portion of the other terminal.

According to this configuration, the guide portion located in the gap can satisfactorily suppress rattling between the respective terminals.

(4) The resilient locking portion of the one terminal may include a basis portion to be arranged along one side edge of the guided portion of the other terminal, and the basis portion may constitute the guide portion.

According to this configuration, since the resilient locking portion also has a function of the guide portion, the configuration can be simplified.

(5) The resilient locking portions may project in the stacking direction from three or more positions on an outer peripheral side of the base portion and be respectively unequally arranged in a circumferential direction of the outer peripheral side of the base portion.

According to this configuration, the respective terminals can be prevented from being assembled at a wrong position in the circumferential direction when the terminals including the resilient locking portions are stacked.

(6) At least two terminals, out of the plurality of terminals, may include the guided portion, the locking portion, the guide portion and the resilient locking portion and are formed to have the same shape.

According to this configuration, since at least two terminals can have the same product number, a cost increase can be suppressed.

### DETAILS OF EMBODIMENTS OF PRESENT DISCLOSURE

Specific examples of embodiments of the present disclosure are described below with reference to the drawings. Note that the present invention is not limited to this illustration, but is represented by claims and intended to include all changes in the scope of claims and in the meaning and scope of equivalents.

### First Embodiment

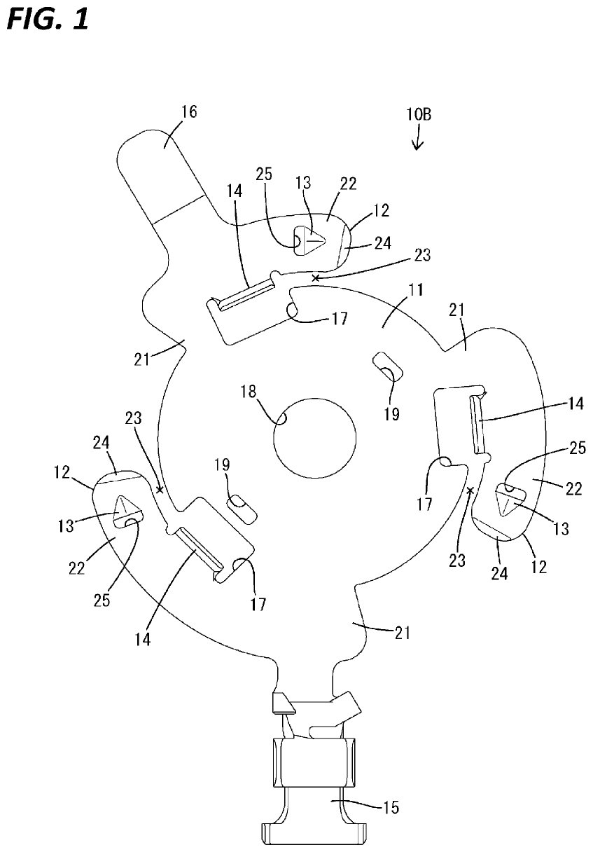

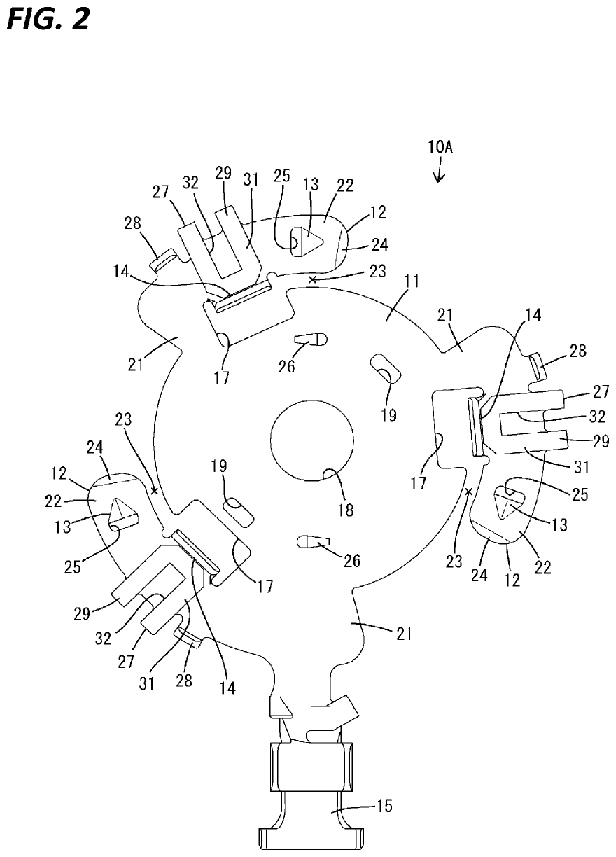

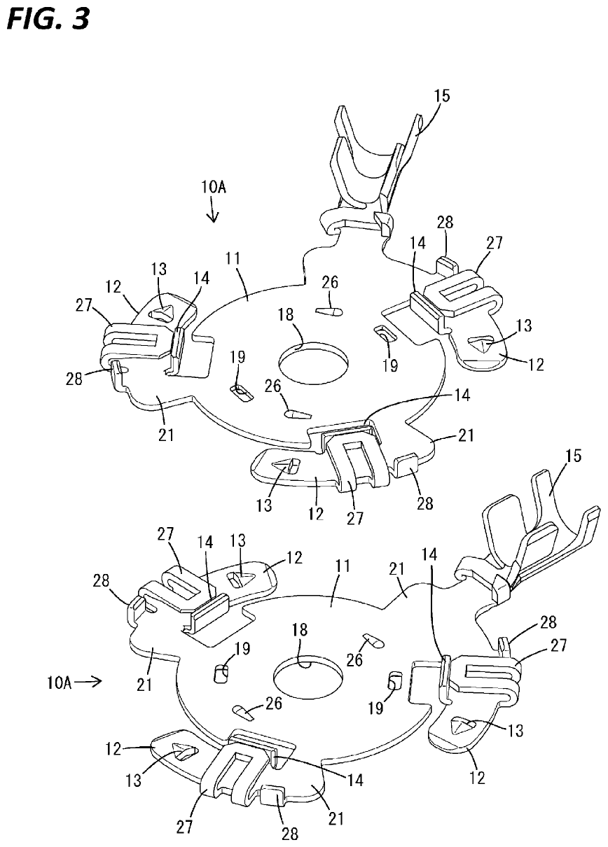

A combination terminal according to a first embodiment is provided with a plurality of terminals 10A, 10B. As shown in FIGS. 1 and 2, each terminal 10A, 10B includes a flat plate-like base portion 11 and assembled with another terminal while plate surfaces of the terminals are caused to face each other. Each terminal 10A, 10B is connected to an end part of an unillustrated wire. In the case of the first embodiment, each wire is connected and grounded to a ground portion such as a body of a vehicle by the combination terminal. Note that, in the following description, a vertical direction is based on FIGS. 3, 7 and 9. The vertical direction is a facing direction of the plate surfaces of the respective terminals 10A, 10B and also a stacking direction of the respective terminals 10A, 10B.

Each terminal 10A, 10B is integrally formed, such as by bending a plate member made of electrically conductive metal. In the case of the first embodiment, the respective terminals 10A, 10B are two types of terminals having different shapes. Specifically, the respective terminals are composed of a plurality of first terminals 10A having the same shape and one second terminal 10B. In the combination terminal, the second terminal 10B is arranged in an uppermost level and three first terminals 10A are arranged in the second and subsequent levels except the uppermost level.

As shown in FIG. 1, the second terminal 10B includes the base portion 11, guided portions 12, locking portions 13, guide portions 14, a crimping portion 15 and a hooking portion 16. The base portion 11 is in the form of a flat plate circular in a plan view except cutouts 17 formed at three circumferential positions of an outer periphery.

A circular through hole 18 is formed to penetrate through a central part of the base portion 11. A shaft portion of an unillustrated bolt is inserted into the through hole 18 of the base portion 11 from above the combination terminal. A head portion of the bolt is, for example, placed on the upper surface of the base portion 11 of the second terminal 10B. The base portion 11 is formed with a pair of contact point receiving portions 19 at positions on both sides in a radial direction across the through hole 18. Each contact point receiving portion 19 is in the form of a slit open in the base portion 11.

The guided portion 12 is plate-like and a plurality of the guided portions 12 project from the outer peripheral edge of the base portion 11. Plate surfaces of each guided portion 12 are continuous with those of the base portion 11 on the same planes. Specifically, each guided portion 12 includes a base end portion 21 projecting radially outward from each of three positions on the outer peripheral edge of the base portion 11 and a body portion 22 extending in a curved manner along the circumferential direction of the outer periphery of the base portion 11 from the base end portion 21. The base end portion 21 of each guided portion 12 is arranged at a position adjacent to each cutout 17. Further, the base end portions 21 of the respective guided portions 12 are arranged not at equal intervals of 120°, but at unequal intervals in the circumferential direction on the outer peripheral edge of the base portion 11.

A gap 23 is formed between the inner peripheral edge of the body portion 22 and the outer peripheral edge of the base portion 11. The gap 23 is closed at one end in the circumferential direction by the base end portion 21 and open on the other end in the circumferential direction. An inclined chamfered portion 24 is formed on a tip part of the upper surface of the body portion 22.

The locking portion 13 is provided on each guided portion 12. The locking portion 13 is in the form of a claw triangular in a plan view and formed by press-working to bulge upward with a cut 25 along a radial direction as a boundary at a position near the tip part of the body portion 22.

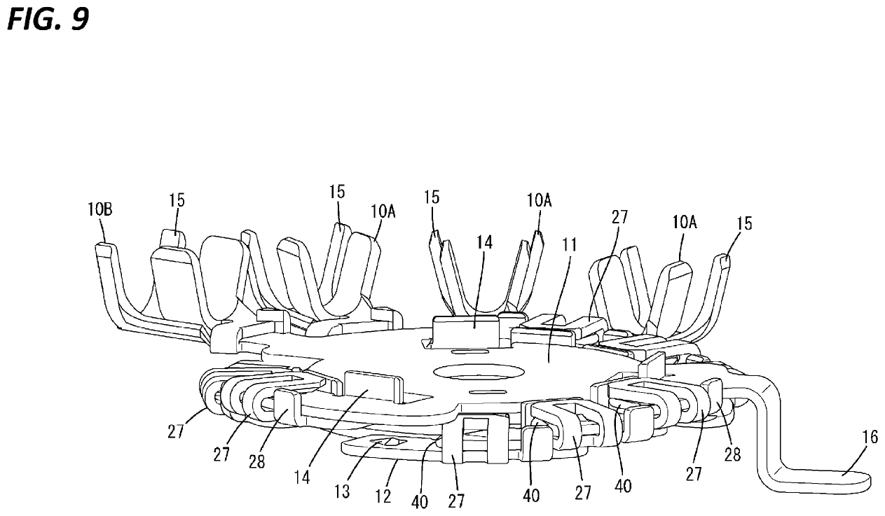

The guide portion 14 is provided on each guided portion 12. The guide portion 14 is rectangular in a side view as shown in FIG. 9 and formed to rise from an inner peripheral edge closer to the base portion 11, out of both side edges in a plate width direction of the body portion 22, and extend in the circumferential direction or tangential direction along the inner peripheral edge of the body portion 22. The guide portion 14 is arranged to face the cutout 17 at a position near the base end portion 21. When the second terminal 10B is in a developed state before being bent, a rectangular tongue piece located in the cutout 17 is bent and raised at a right angle toward the body portion 22 to form the guide portion 14.

The crimping portion 15 projects radially outward from the base end portion 21 of one guided portion 12. The base end portion 21 (lower base end portion 21 of FIG. 1) connected to the crimping portion 15 is formed to be wider in the circumferential direction than the other base end portions 21. The crimping portion 15 is crimped and connected to the end part of the unillustrated wire.

The hooking portion 16 is in the form of a plate piece and projects radially outward from one guided portion 12 located on a side opposite to a side where the crimping portion 15 is formed in the circumferential direction. As shown in FIG. 9, the hooking portion 16 includes a stepped part bent downward at an intermediate position. The hooking portion 16 is hooked to an unillustrated hooking object and functions to restrict the rotation of the combination terminal.

As shown in FIG. 2, the first terminal 10A includes contact point portions 26, resilient locking portions 27 and outer periphery guide portions 28 in addition to the respective portions of the aforementioned second terminal 10B. On the other hand, the first terminal 10A does not include the hooking portion 16. Note that there are no structural differences in the base portions 11, the guided portions 12, the locking portions 13, the guide portions 14 and the crimping portions 15 between the first and second terminals 10A, 10B. Thus, these portions are denoted by the same reference signs and repeated description is omitted.

A pair of the contact point portions 26 are formed at positions on both sides in a radial direction across the through hole 18 in the base portion 11. The contact point portions 26 and the contact point receiving portions 19 are arranged at intervals in the circumferential direction in the base portion 11. The contact point portion 26 is rib-like and formed by press-working to bulge upward of the base portion 11.

The resilient locking portion 27 is provided on each guided portion 12. As shown in FIG. 3, the resilient locking portion 27 is formed by folding a U-shaped loop-shaped part projecting radially outward from the outer peripheral edge distant from the base portion 11, out of the both side edges in the plate width direction of the body portion 22, radially inward. Specifically, the resilient locking portion 27 includes a basis portion 29 rising from the outer peripheral edge of the body while being curved radially outward and a locking arm portion 31 projecting radially inward from the basis portion 29 to intersect a tangential direction as shown in FIG. 2. Further, a locking hole 32 is formed to penetrate through the basis portion 29 and the locking arm portion 31 inside the resilient locking portion 27.

The tip of the locking arm portion 31 is arranged to proximately and parallelly face the outer side surface of the guide portion 14. Further, the locking arm portion 31 is arranged to parallelly face at a distance from the upper surface of the body portion 22. This distance corresponds to a plate thickness of the body portion 22. The resilient locking portion 27 is resiliently deformable in the vertical direction with the basis portion 29 as a fulcrum.

Here, since the respective guided portions 12 are arranged at unequal intervals in the circumferential direction, the resilient locking portions 27 formed on the respective guided portions 12 are also arranged at unequal intervals in the circumferential direction. Specifically, the respective resilient locking portions 27 are, for example, arranged at intervals of 110°, 110° and 140° on an outer peripheral side of the base portion 11.

The outer periphery guide portion 28 is provided on each guided portion 12. As shown in FIG. 3, the outer periphery guide portion 28 is rectangular in a side view, rises from a position on the side of the base end portion 21 on the outer peripheral edge of the body portion 22 and extends shorter than the guide portion 14 in the circumferential direction or tangential direction. The outer periphery guide portion 28 is arranged side by side with the resilient locking portion 27 on the outer peripheral edge of the body portion 22.

Next, an assembly procedure of the combination terminal according to the first embodiment is described.

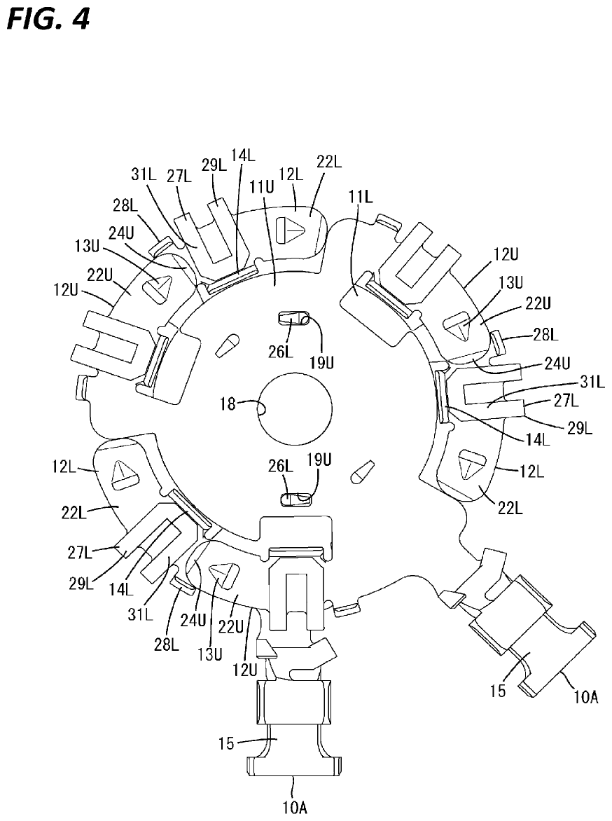

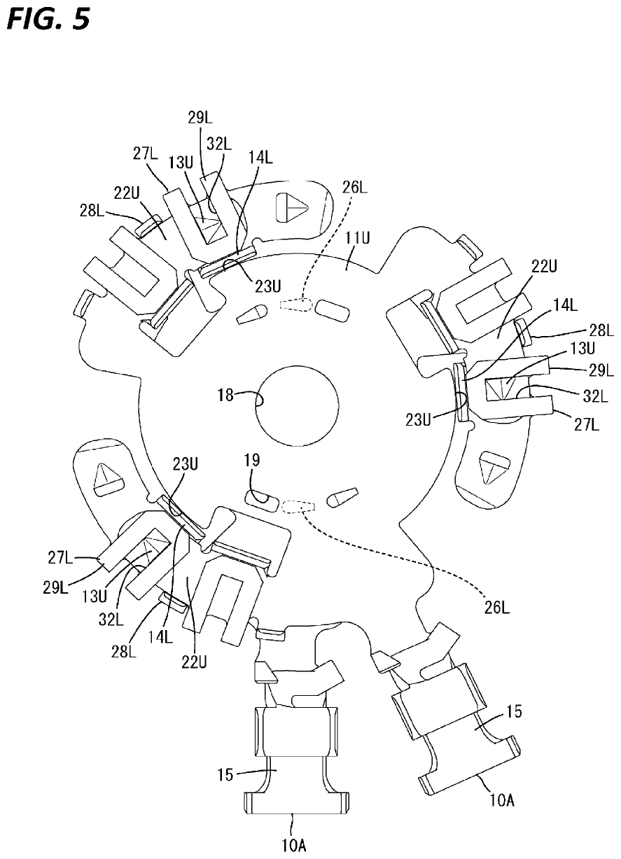

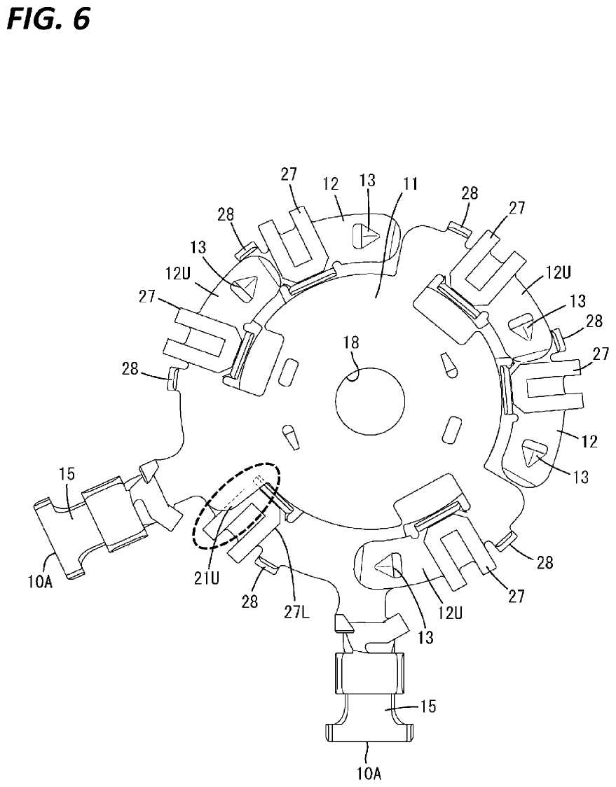

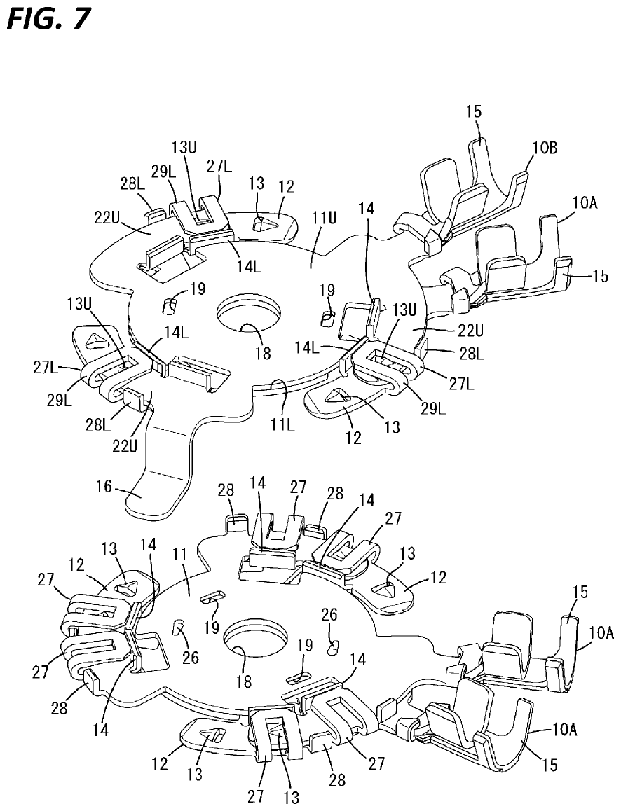

As shown in FIG. 7, a combination terminal in two lower levels composed of two first terminals 10A and a combination terminal in two upper levels composed of one first terminal 10A and one second terminal 10B are respectively formed. Note that, in the following description, “U” is added to an end of a reference sign of each component of the terminal 10A, 10B located relatively on an upper side, “L” is added to an end of a reference sign of each component of the terminal 10A, 10B located relatively on a lower side, out of the terminals 10A, 10B adjacent in the vertical direction, whereby the “upper side” and the “lower side” are distinguished. “U” and “L” are added to the ends of the reference signs of the respective components in FIGS. 4 and 5 and parts of FIGS. 6 and 7 for the convenience of drawing.

In forming the combination terminal in the two lower levels, the base portions 11 of the two first terminals 10A are so stacked in the vertical direction that the respective through holes 18 are concentric and, as shown in FIG. 4, set in such an initial state that the respective crimping portions 15 are spaced apart by an opening angle close to 45° centered on the through holes 18.

In the initial state, tip parts of the body portions 22U of the guided portions 12U are located on the sides of the base end portions 21L of the guided portions 12L. Further, the outer peripheral edges of the tip parts of the body portions 22U are arranged to contact the inner side surfaces of the outer periphery guide portions 28L. Furthermore, the inner side surfaces of the guide portions 14L are arranged to contact along the outer peripheral edge of the base portion 11U. Then, the respective contact point portions 26L are fit into the respective contact point receiving portions 19U and the respective first terminals 10A are temporarily fixed in the initial state.

Subsequently, the respective first terminals 10A in the initial state are relatively rotated in the circumferential direction about the through holes 18. In the case of the first embodiment, the respective first terminals 10A are rotated in directions to bring the respective crimping portions 15 closer to each other. Then, the body portions 22U of the guided portions 12U enter between the locking arm portions 31L of the resilient locking portions 27L and the upper surfaces of the body portions 22L while sliding on the upper surfaces of the body portions 22L. Further, in a rotation process, the outer side surfaces of the guide portions 14L slide along the inner peripheral edges of the body portions 22U of the guided portions 12U and the respective inner side surfaces of the outer periphery guide portions 28L and the basis portions 29L slide along the outer peripheral edges of the guided portions 12U. Further, in the rotation process, the locking portions 13U are guided by the chamfered portions 24U and slide on the locking arm portions 31L, whereby the resilient locking portions 27L are resiliently deformed.

When the rotation is completed, the resilient locking portions 27L return to an initial natural state and, as shown in FIG. 5, the locking portions 13U are fit into the locking holes 32L of the resilient locking portions 27L. In this way, rotational movements of the respective first terminals 10A are stopped and the respective first terminals 10A are assembled in a proper state. At this time, the respective crimping portions 15 are spaced apart by an opening angle smaller than 45°.

Further, when the rotation is completed, the guide portions 14L are located in the gaps 23U between the body portions 22U and the base portion 11U. The outer side surfaces of the guide portions 14L are arranged to contact the inner peripheral edges of the body portions 22U, and the inner side surfaces of the guide portions 14L are arranged to contact the outer peripheral edges of the base portion 11U. That is, the guide portions 14L are sandwiched between the body portions 22U and the base portion 11U.

The inner side surfaces of the outer periphery guide portions 28L are arranged to contact the outer peripheral edges of the body portions 22U. Further, the inner side surfaces of the basis portions 29L are also arranged to contact the outer peripheral edges of the body portions 22U and fulfills a function as guide portions. By arranging the guide portions 14L, the basis portions 29L and the outer periphery guide portions 28L to contact along the base portion 11U and the body portions 22U in this way, the rattling of the respective first terminals 10A in the radial direction is suppressed. Further, when the rotation is completed, the respective contact point portions 26L are in contact with the base portion 11U and the respective first terminals 10A are conductively connected.

Note that, in the case of the first embodiment, the respective resilient locking portions 27 are unequally arranged in the circumferential direction on the outer peripheral side of the base portion 11 as already described. Thus, if an attempt is made to erroneously assemble the respective first terminals 10A in the circumferential direction, erroneous assembly of the respective first terminals 10A is prevented, such as due to the interference of the base end portions 21U of the guided portions 12U with the resilient locking portions 27L as shown in FIG. 6. That is, it can be prevented that the respective first terminals TOA in an erroneously assembled state are temporarily fixed in the initial state.

Further, in forming the combination terminal in the two upper levels, the base portion 11U of the second terminal 10B is so stacked on the upper surface of the base portion 11L of the first terminal 10A that the through holes 18 are concentric with each other to set an initial state. Subsequently, the first terminal TOA and the second terminal 10B are relatively rotated. Then, similarly to the combination terminal in the lower two levels, the locking portions 13U are locked to the resilient locking portions 27L and the guide portions 14L, the basis portions 29L and the outer periphery guide portions 28L are arranged to contact along the base portion 11U and the body portions 22U as shown in FIG. 7. In this way, the first terminal TOA and the second terminal 10B are fixed in a positioned state.

Subsequently, as shown in FIG. 7, the combination terminal in the two upper levels is arranged above the combination terminal in the two lower levels. In that state, the respective combination terminals in the two lower levels and two upper levels are so stacked as to cause the lower surface of the first terminal TOA in the lower level in the combination terminal in the two upper level to face the upper surface of the first terminal 10A in the upper level in the combination terminal in the two lower levels, and set in an initial state. Thereafter, as in the case of the combination terminal in the two lower levels, the respective combination terminals are fixed in a positioned state if being relatively rotated.

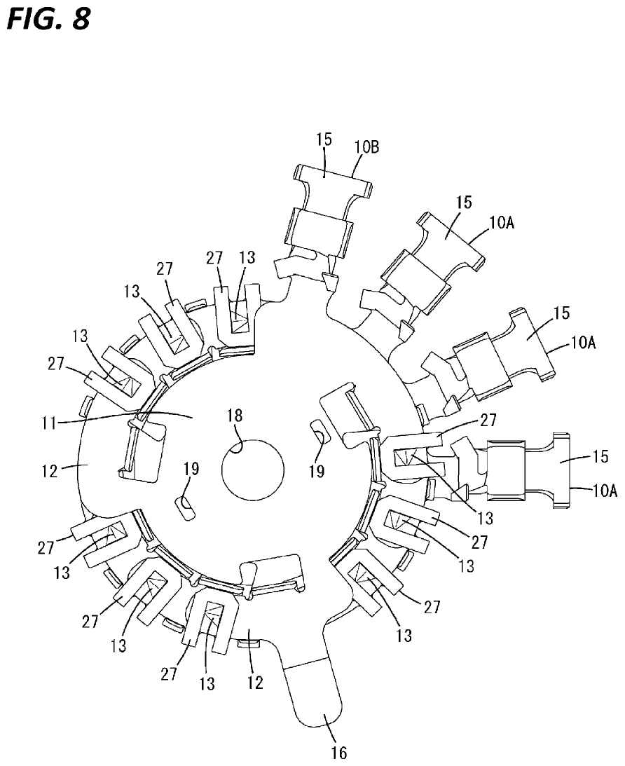

In the case of the first embodiment, four crimping portions 15 are arranged at fixed intervals in a range of an opening angle of 90° centered on the through holes 18 in the combination terminal as shown in FIG. 8. Further, since the respective guided portions 12 are stacked while the tip positions thereof are shifted in the circumferential direction as shown in FIG. 9, steps 40 are formed between the respective terminals 10A and 10B. Thus, the respective terminals 10A, 10B are stacked in a step-like manner via the steps 40 from the lowermost level to the uppermost level.

As described above, according to the first embodiment, the guide portions 14L are arranged to be able to contact along the body portions 22U of the guided portions 12U and the locking portions 13U are locked to the resilient locking portions 27L, whereby the respective terminals 10A, 10B can be positioned and fixed with the rattling thereof suppressed. Therefore, a separate member for positioning and fixing is not required and an increase in the number of components can be prevented. Further, assembly time can also be saved.

Particularly, in the case of the first embodiment, the combination terminal includes the plurality of first terminals 10A and the respective first terminals 10A include the guided portions 12, the locking portions 13, the guide portions 14 and the resilient locking portions 27 and are formed to have the same shape. Thus, the respective first terminals 10A can have the same product number, and the cumbersomeness of manufacturing and management due to many product numbers can be solved. As a result, a cost increase can be suppressed.

Further, since the guide portions 14L and the basis portions 29L are paired and arranged along the both side edges of the body portions 22U, the assembly of the terminals 10A, 10B is satisfactorily guided and the terminals 10A, 10B are satisfactorily positioned. Particularly, since the basis portions 29L of the resilient locking portions 27L serve as guide portions, the configurations of the terminals 10A, 10B can be simplified.

Further, since the guide portions 14L are located in the gaps 23U and arranged to be able to contact the base portion 11U and the body portions 22U, rattling between the terminals 10A, 10B can be satisfactorily suppressed.

Furthermore, since the respective resilient locking portions 27 are unequally arranged in the circumferential direction on the outer peripheral side of the base portion 11, the terminals 10A, 10B can be prevented from being assembled at a wrong position in the circumferential direction.

### Second Embodiment

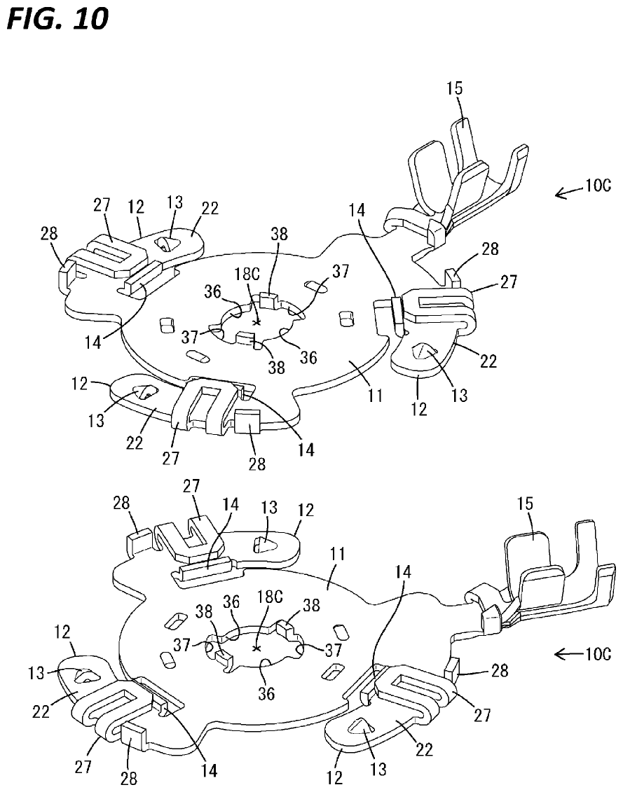

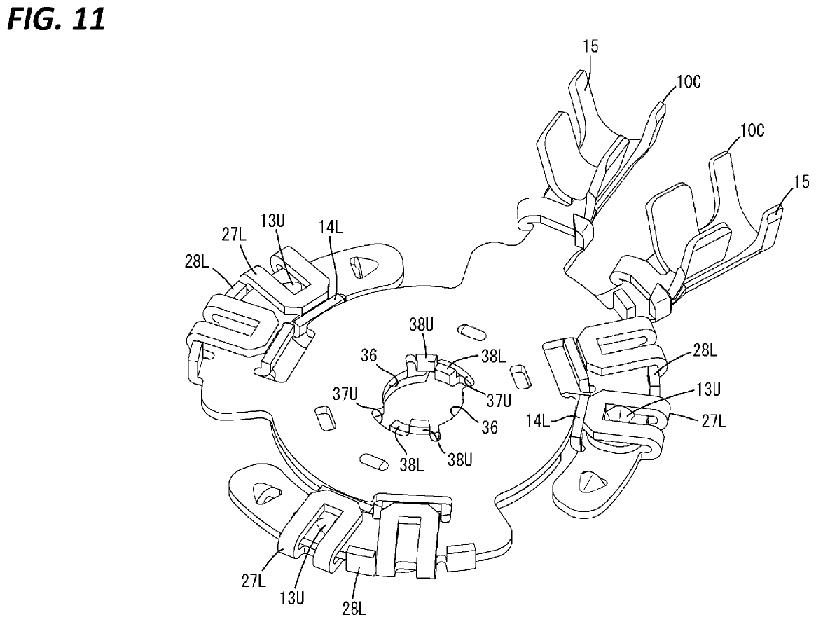

Next, a combination terminal of a second embodiment is described using FIGS. 10 and 11. The combination terminal is composed of two terminals 20C having the same shape. The terminal 10C has a structure similar to that of the first terminal 10A and includes a base portion 11, guided portions 12, locking portions 13, guide portions 14, a crimping portion 15, resilient locking portions 27 and outer periphery guide portions 28. The terminal 10C differs from the first terminal 10A in the shape of a through hole 18C of the base portion 11.

The through hole 18C of the terminal 10C forms a noncircular opening in a central part of the base portion 11 as shown in FIG. 10. The inner peripheral edge of the through hole 18C of the base portion 11 includes a pair of small-diameter arc portions 36 facing each other via a center of the through hole 18C and a pair of large-diameter arc portions 37 facing each other in a direction orthogonal to a facing direction of the small-diameter arc portions 36. A radial dimension of each large-diameter arc portion 37 is larger than that of each small-diameter arc portion 36. Further, inner periphery guide portions 38 rising from the respective large-diameter arc portions 37 are formed on the inner peripheral edge of the through hole 18C of the base portion 11. The inner periphery guide portions 38 are rectangular in a side view and arranged to face each other via the center of the through hole 18C on one circumferential side of each large-diameter arc portion 37.

In assembling the respective terminals 10C, the respective terminals 10C are stacked and set in an initial state as in the first embodiment, and relatively rotated in that state. The locking portions 13U are locked to the resilient locking portions 27L and the respective terminals 10C are held in an assembled state as shown in FIG. 11 as in the first embodiment on outer peripheral sides of the respective terminals 10C. Further, the respective terminals 10C are positioned with rattling suppressed on the outer peripheral sides by arranging the guide portions 14L, basis portions 29L and the outer periphery guide portions 28L along the base portion 11U and the body portions 22U. Note that “U”, “L” is added to an end of a reference sign of each component as in the first embodiment, whereby an “upper side” and a “lower side” are distinguished.

Further, in the case of the second embodiment, when the respective terminals 10C are in the initial state, the inner periphery guide portions 38L are arranged on the other circumferential sides of the large-diameter arc portions 37U on the inner peripheral sides of the respective terminals 10C. In a rotation process, the outer side surfaces of the inner periphery guide portions 38L slide in the circumferential direction along the large-diameter arc portions 37U and guide rotational movements of the respective terminals 10C. When the respective terminals 10C reach an assembled position, the inner periphery guide portions 38L are displaced toward circumferentially central sides of the large-diameter arc portions 37U and arranged to butt against the side edges of the inner periphery guide portions 38U as shown in FIG. 11. In this way, the rotational movements of the respective terminals 10C are stopped.

According to the second embodiment, the respective terminals 10C are positioned with rattling suppressed also on the inner peripheral sides by the outer side surfaces of the inner periphery guide portions 38L contacting along the large-diameter arc portions 37U. Further, the inner periphery guide portions 38L can function as stoppers for stopping the rotational movements of the respective terminals 10C by contacting the inner periphery guide portions 38U.

### Other Embodiments of Present Disclosure

The embodiments disclosed this time should be considered illustrative in all aspects, rather than restrictive.

In the case of the first and second embodiments, the respective terminals are assembled with each other by being relatively rotated. However, as another embodiment, terminals may be assembled by being linearly slid along plate surfaces thereof.

In the case of the first and second embodiments, the guided portions and the resilient locking portions are arranged at three positions on the outer peripheral side of the base portion. However, as another embodiment, a guided portion and a resilient locking portion may be arranged at one position on an outer peripheral side of a base portion or guided portions and resilient locking portions may be arranged at four or more positions on an outer peripheral side of a base portion.

In the case of the first and second embodiments, the resilient locking portions and the guide portions are provided to be integrally continuous with the guided portions. However, as another embodiment, at least either resilient locking portions or guide portions may be provided separately from guided portions.

In the case of the first embodiment, the second terminal includes no resilient locking portion. However, as another embodiment, a second terminal may also include resilient locking portions.

In the case of the first embodiment, the second terminal includes the guide portions. However, as another embodiment, a second terminal may include no guide portion.

List of Reference Numerals

| 10A | first terminal (terminal) |
|---|---|
| 10B | second terminal (terminal) |
| 10C | terminal |
| 11, 11L, 11U | base portion |
| 12, 12L, 12U | guided portion |
| 13, 13U | locking portion |
| 14, 14L | guide portion |
| 15 | crimping portion |
| 16 | hooking portion |
| 17 | cutout |
| 18, 18C | through hole |
| 19, 19U | contact point receiving portion |
| 21, 21L, 21U | base end portion |
| 22, 22L, 22U | body portion |
| 23, 23U | gap |
| 24, 24U | chamfered portion |
| 25 | cut |
| 26, 26L | contact point portion |
| 27, 27L | resilient locking portion |
| 28, 28L | outer periphery guide portion (guide portion) |
| 29, 29L | basis portion (guide portion) |
| 31, 31L | locking arm portion |
| 32 | locking hole |
| 36 | small-diameter arc portion |
| 37, 37U | large-diameter arc portion |
| 38, 38L, 38U | inner periphery guide portion (guide portion) |
| 40 | step |

1. A combination terminal, comprising a plurality of terminals to be stacked on each other,
each of the plurality of terminals including a plate-like base portion, a plate-like guided portion projecting from the base portion and a locking portion formed on the guided portion, and
out of the terminals adjacent in a stacking direction, one of the terminals including a guide portion to be arranged along the guided portion of the other terminal and a resiliently deformable resilient locking portion to be locked to the locking portion of the other terminal.

2. The combination terminal of claim 1, wherein a pair of the guide portions of the one terminal are arranged respectively along both side edges of the guided portion of the other terminal.

3. The combination terminal of claim 1, wherein:
a gap is formed between the guided portion and the base portion, and
the guide portion of the one terminal is located in the gap of the other terminal and arranged to be able to contact the base portion and the guided portion of the other terminal.

4. The combination terminal of claim 1, wherein:
the resilient locking portion of the one terminal includes a basis portion to be arranged along one side edge of the guided portion of the other terminal, and
the basis portion constitutes the guide portion.

5. The combination terminal of claim 1, wherein the resilient locking portions project in the stacking direction from three or more positions on an outer peripheral side of the base portion and are respectively unequally arranged in a circumferential direction of the outer peripheral side of the base portion.

6. The combination terminal of claim 1, wherein at least two terminals, out of the plurality of terminals, include the guided portion, the locking portion, the guide portion and the resilient locking portion and are formed to have the same shape.
